(19) United States
(12) Patent Application Publication
(10) Pub. No.: US 2020/0122904 A1
(43) Pub. Date: Apr. 23, 2020

(54) COFFEE BAG VENT

(71) Applicant: LaserSharp FlexPak Services, LLC, Vadnais Heights, MN (US)

(72) Inventor: Kenneth Klann, Vadnais Heights, MN (US)

(21) Appl. No.: 16/716,830

(22) Filed: Dec. 17, 2019

Related U.S. Application Data
(63) Continuation of application No. 15/492,507, filed on Apr. 20, 2017, now abandoned.
Application No. 15/492,507 is a division of application No. 15/229,052, filed on Aug. 4, 2016, now abandoned.
(60) Provisional application No. 62/331,352, filed on May 3, 2016.

(51) Int. Cl. B65D 47/32; B31B 50/84; B65D 77/22; B32B 15/20; B32B 15/09; B32B 27/34; B32B 15/088; B32B 27/30; B32B 3/26; B32B 27/20; B65D 81/20; B65D 65/14; B32B 27/32; B32B 27/36; B32B 27/08; B65D 65/40; B65D 85/00

(52) U.S. Cl. CPC B65D 47/32; B31B 2170/20; B65D 77/225; B32B 15/20; B32B 15/09; B32B 27/34; B32B 15/088; B32B 27/306; B32B 3/26; B32B 27/20; B65D 81/2084; B65D 65/14; B32B 27/32; B32B 3/266; B32B 27/36; B32B 27/08; B65D 65/40; B65D 85/70; B31B 50/84

(57) ABSTRACT

A vent for a package includes a multilayer laminate film comprising a vent having a first breach, a second breach, and a laser-formed channel extending therebetween, and the length and cross-sectional area of the laser-formed channel are configured to exhaust CO₂ at a rate greater than a counter-flow diffusion rate for oxygen or water vapor.

### PRIORITY CLAIMS

This application claims priority to and is a continuation of U.S. patent application Ser. No. 15/492,507 filed Apr. 20, 2017, which is a division of U.S. patent application Ser. No. 15/229,052 filed on Aug. 4, 2016 claiming priority to U.S. provisional patent application No. 62/331,352 filed on May 3, 2016, the entire contents of those applications herewith incorporated by reference.

### BACKGROUND

Roasted coffee creates an outflow of gas after its roasting, known as off-gassing. For example, 1 kg of fresh roasted coffee bean could generate about 10 liters of CO₂ gas at a decreasing rate from the time of roasting. It can be important to package the coffee in a way that keeps its freshness while compensating for this gas generation.

A packaging film that is a high barrier to oxygen and moisture is typically used in packaging to preserve the coffee from degrading. An airtight flexible package would accumulate CO₂ gas and build air pressure until the package ruptures. A common solution in use today is to install a 3-piece molded plastic valve that is welded to the interior of the coffee bag. The film material is mechanically breached within the circular valve weld to allow CO₂ to escape though the valve and the breach in the film. The valve prevents air from entering the package but allows the CO₂ to vent. A vent that allows CO₂ to escape must also address the negative effects of allowing the fresh roasted aroma from escaping as well as allowing oxygen and moisture from entering the package which will degrade the sensory aspects of the coffee as well as shorten the shelf life. Packaged items other than coffee also have an off-gassing effect that would benefit from this type of vent, with or without a sealing film valve.

### SUMMARY

In one aspect, a vent for a package comprises a multilayer laminate film comprising a vent having a first breach, a second breach, and a laser-formed channel extending therebetween, and the length and cross-sectional area of the laser-formed channel are configured to exhaust CO₂ at a rate greater than a counter-flow diffusion rate for oxygen or water vapor.

In another aspect, a multilayer laminate film comprises a vent having a first breach configured for communication with an interior of a package comprising the multilayer laminate film, a second breach configured for communication with an exterior of the package, and a laser-formed channel communicating therebetween, wherein a diameter of the laser-formed channel is between about 50 microns to about 200 microns.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings, in which:

FIG. 1 (Prior Art) shows a drawing of common film construction for flexible packaging;

FIGS. 2A and 2B show an embodiment with a breach allowing gas escape;

FIG. 3 shows using a focused CO₂ laser beam for processing;

FIG. 4 shows another embodiment with a CO₂ laser beam processing a EVOH barrier;

FIG. 5 shows processing using a short wavelength laser;

FIG. 6 illustrates forming an interior breach with a laser;

FIGS. 7A and 7B show an embodiment using a short wavelength laser to process material;

FIGS. 8A, 8B and 8C show an embodiment using an exterior sealing film valve;

FIGS. 9A-9C show an alternative embodiment using concentric circles for sealing;

FIGS. 10A-10B show a delaminated area to prevent oil from blocking the airflow;

FIG. 11 illustrates the exterior of the package showing the exterior breach opening;

FIGS. 12A-12B show an embodiment using a laser etched vent and seal film valve; and

FIGS. 13A-13B show an embodiment where a laser etched vent is formed on a patch.

### DETAILED DESCRIPTION

Embodiments herein describe a laser etched vent that addresses many of the problems discussed above.

An embodiment described herein may form the package using the techniques described in our patent application Ser. No. 13/899,387, filed May 21, 2013.

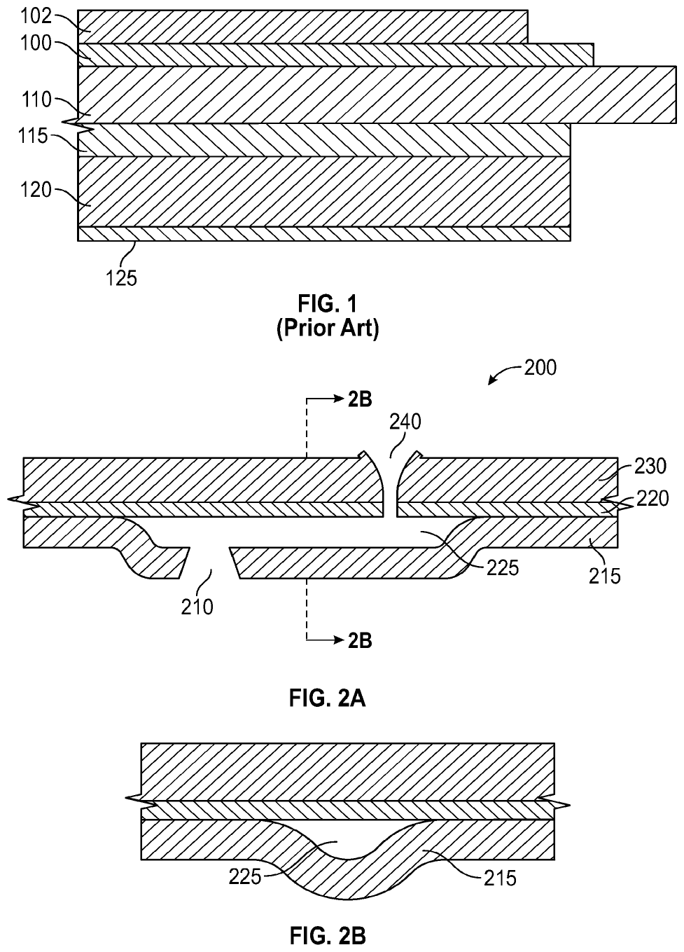

Advantages to the laser etched vent include but are not limited to lower cost. No additional material or additional steps in the manufacturing process are required other than the packaging film itself or film type valve. These parts are much less expensive than the standard 3-piece molded valve and its complicated welding process to the package film. Further, overall film thickness can be reduced considerably from the usual basic film construction of flexible packaging for retail coffee as shown in FIG. 1 (Prior Art). Extra layers of polyester (PET) have been used as shown in the embodiment of FIG. 1 (Prior Art), in order to strengthen the film structure so that the valve can be molded to the package. Embodiments as described herein do not require the valve to be welded and hence the package can be made thinner and less expensive.

Another advantage of this system is ease of production and process flow. The laser etched vent with or without the additional sealing film valve can be created and applied onto any roll stock prior to packaging coffee. As described herein, the vent can be formed in a way that allows the vent to be crushed, in order to roll the packaging film onto the roll stock. Then, when the roll is unrolled, the laser etched vent will inflate in size. In contrast, the standard 3-piece valve must be welded onto the packaging film at the time of packaging the coffee. This requirement is because the roll stock of packaging film cannot be rewound after the bulky standard valve has been welded in place on the film.

The laser etched vent of the present invention also has better oxygen and moisture barrier properties. The laser etched vent can be designed to vent exactly to the requirements for any type of coffee bean, ground or whole bean, which are currently packaged in coffee bags.

The laser etched vent can be tailored to have the properties of a smaller aperture. This in turn will allow the specific amount of CO₂ to escape and will in turn restrict air from outside of the package to enter. This will prevent excessive amounts of oxygen and moisture to spoil the coffee. The addition of a sealing film valve further restricts outside air from entering thus extending the shelf life of the coffee within the bag.

Construction and design of the laser etched vent may utilize the common structure of a flexible packaging film. A common film construction of flexible packaging for retail coffee is shown in FIG. 1 (Prior Art). An exterior printed polyester (PET) layer(s) 100, 102 forms the outer layer of the cross section of the package. The outer layer is underlied. by an intermediate barrier layer 110. This intermediate layer 110 is typically formed of a foil metalized layer, e.g., a metalized PET, aluminum foil, or ethylene-vinyl-alcohol (EVOH) material. There can be an optional additional layer 115 of PET or PA (polyamide Nylon) on the interior surface of the barrier layer 110. The interior layer 120 that holds and packages the product is formed of polyethylene (PE) or polypropylene (PP) and often an additional sealing layer 125. Normally this can also be PE or PP.

The embodiments described herein explain formation of a laser etched vent. One embodiment forms the vent by using the selective absorption of different frequencies of laser light in each of the multiple layers of a packaging film.

A breach is formed as shown in FIGS. 2A and 2B, allowing for CO₂ to escape. The breach 200 is defined by interconnected features formed into common high barrier coffee packaging film. The film that is used can commonly range in thickness of 50 to 180 microns (0.002″ to 0.007″), although other thicknesses can be used. In this embodiment, the breach is formed through three layers, including an interior layer 215, an intermediate layer 220, and an outer layer 230. The interior layer 215 can be for example a PE, PE-PET, PP or PP-PET sealing layer. PET represents polyester. The sealing layer is commonly PE or PP with or without a PET or PA. Other materials are possible including co-polymers. The interior breach 210 is at a first lateral location in the interior layer 215. The interior breach then forms a channel 225 between an inner wall of the interior layer 215 and an outer wall of the intermediate layer 220. The intermediate layer 220 may be formed of different materials, and in this embodiment is formed of a metalized layer, foil, or EVOH, for example. The interior breach 210 is formed at a first lateral location, which leads via the channel 225 to a second lateral location where the exterior breach 240 is located.

The channel 225 is formed along the surface of the intermediate layer 220 without compromising the exterior or interior layers. The channel 225 also extends into the interior, as shown for example in FIG. 2B. The channel 225 causes the interior layer 215 to bulge at areas surrounding the channel. This forms an area which allows gas to extend through the channel 225 from the interior breach 210 to the exterior breach 240.

The exterior breach 240 is formed in both the intermediate layer 220 and the exterior layer 230, where the exterior layer 230 can be formed, for example, of printed layers of PET. The breaches are sized sufficiently to expel the CO₂ gas evolved from the material inside, preferably coffee, without increasing the interior pressure of the package beyond an acceptable point. The design of the laser etched vent preferably does not exceed the maximum required air flow by more than a safety factor, as a determined percentage over the known rate to reduce the risk of excessive pressure buildup. The restriction to air flow is proportional to a factor of the intermediate breaches' cross-sectional area and length. One embodiment may use multiple long narrow channels that would release the same amount of CO₂ and have a lower OTR value.

Limiting the airflow though the etched feature to little more than the maximum required amount also limits the amount of oxygen and moisture that is allowed into the package. Oxygen and moisture being allowed into the package tends to degrade the coffee in the package. The gradual generation of CO₂ flowing though the etched feature effectively eliminates the counter flow of exterior air and moisture from entering the package when the velocity of CO₂ flowing out of the package is greater than the diffusion rate for oxygen or water vapor. The flow of exterior air and moisture into the package is restricted to conditions where the interior pressure of the package is equal to or less than the exterior air pressure, that is to say after the CO₂ gas has evolved from the coffee beans or grounds. The addition of another layer covering the exterior breach, e.g., a sealing film valve further limits the counter flow of air into the package while only restricting the exhaust of CO₂ slightly.

According to another embodiment, the channels are sized to seal or partially seal with the gradual swelling from absorption of oil from the coffee into the PE or PP interior layer. This swelling would decrease the ability to vent CO₂ as the amount of CO₂ that needed to be vented decreased. This sealing would decrease the ability of oxygen and moisture, however, from entering the package.

FIG. 11 illustrates the exterior of the package with the exterior breach opening 1100 in the packaging film 1110. A sealing film valve 1120 overlies the exterior breach, to even further limit the counter flow of air.

The counter flow of oxygen into a package, as measured by Oxygen Transmission Rate (OTR), per laser etched vent feature and without a sealing film valve is around 1.5 to 0.01 ml per day depending on the design of the vent, specifically the length and the cross sectional area of the channel. The design of the vent is dependent on the venting characteristics and amount of the roasted coffee. A wetted layer (sealing film valve 1120 wetted with oil, as described herein) covering the exterior breach reduces this amount to less than 0.01 ml per day. The industry standard molded valve weld is rated at 0.05 ml per day. A small perforation of 65 microns (0.0026″) in diameter directly though the packaging will exhaust CO₂ at a rate over 100 times the maximum required rate (deflates 500 ml of CO₂ at 1 PSI in 30 minutes) and has a very high OTR of 143 ml per day. When the channels and breaches in the 3-part laser etch vent are in the 50 to 200 micron range, their combined OTR and air release values are equivalent to a hole that is 0.7 microns (0.00003″) in diameter. At a channel cross sectional area and length that would be equivalent to a hole the diameter of 0.7 microns, each laser etched vent would allow an OTR transfer of around 1.5 ml per day and deflate about 500 ml CO₂ at 1 PSI in around 24 hours. Alone, the laser etched vent would be sufficient to preserve the coffee in the package to a period of time after the all CO₂ has been exhausted. The addition of a sealing film vent would extend the coffee preservation time well beyond the CO₂ being exhausted, and beyond the performance of a bag using a standard 3 piece molded valve.

Laser converting the packaging material lowers the cost by eliminating the need for a standard 3-piece molded valve. Laser converting also increases the efficiency of the production process by allowing the conversion to happen offline from the packaging operation. Cumbersome in-line installation of 3-piece molded valves are required due to the valve's bulk prohibiting rolling the film on a core. Laser etching the vent offline, even with the addition of a sealing film valve, will not prevent the film from being rolled on a core or operations in standard flow wrap/filling equipment.

The following provides a more detailed description of the laser etching film structure.

1. Channel

A variety of lasers can be used to etch the channels that control the flow of CO₂ and air. The United States Patent Publication 20150102022A1 illustrates this method. The selective absorption of a focused CO₂ laser beam, coherent light at 10.6 micron nominal wavelength, will preferentially absorb into a PET material more than PE and will mostly reflect off a metalized or foil layer, leaving the foil intact.

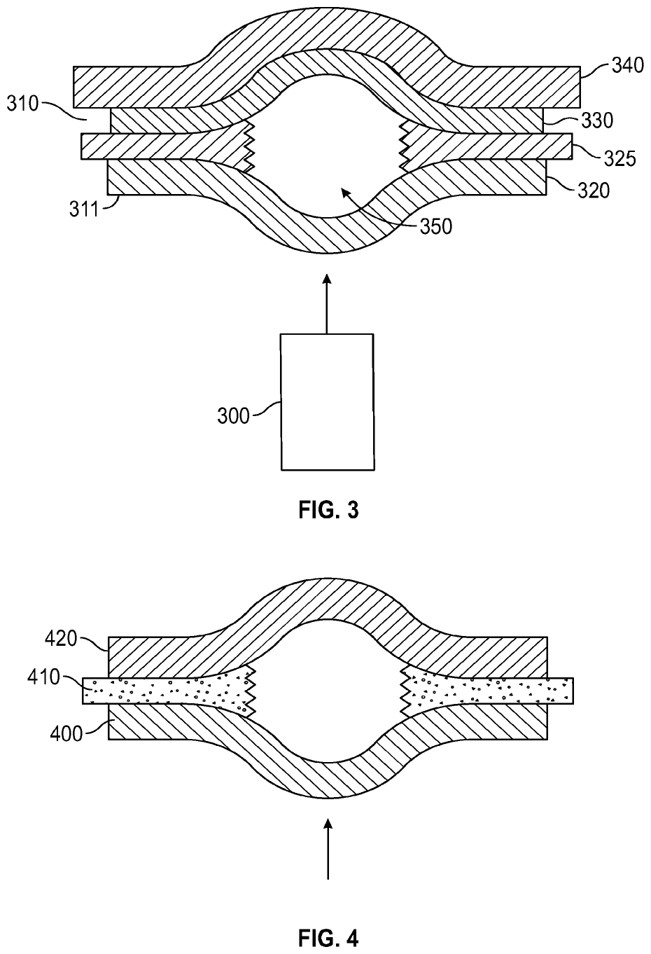

FIG. 3 illustrates a focused CO₂ laser beam 300 applied to the interior side 311 of a film 310. This is applied through one of the layers, where the laser 300 is preferably absorbed by the PET portion of the interior layer 325, after it passes through the PE or PP portion of the interior layer 320. The interior side of the film 310 has a PET layer 325, PP or PE layer 320 forming the interior layer along with the sealer, which is covered with a foil barrier 330. The foil barrier 330 is covered by an exterior PET layer. A channel 350 is created between the foil barrier 330 and the interior PE layer 320 by a laser operating to vaporize the interior PET layer 325 at its focused location. The rest of the structure, including the sealing layer 320, the foil barrier 330, and the exterior PET layer 340 remains intact. Note that channel or chamber 350 causes a bulge in its area, where that bulge is shown extending both into the interior and to the exterior. However, the bulge can extend into only one of interior or exterior in other embodiments.

A preferred method of doing this is by applying a focused CO₂ laser beam from the interior 320 of the film to a foil 330 that is in contact with a PET film 325. The resulting channel is created by the vaporizing the PET film. This will also result in lessening of the reduction of flow which could otherwise be caused by physically crushing the channel. The material that was vaporized leaves a void (or channel) that remains even after the film has been crushed and is then relaxed.

An alternative embodiment removes material through vaporization to form the channel, with or without the resulting bulge.

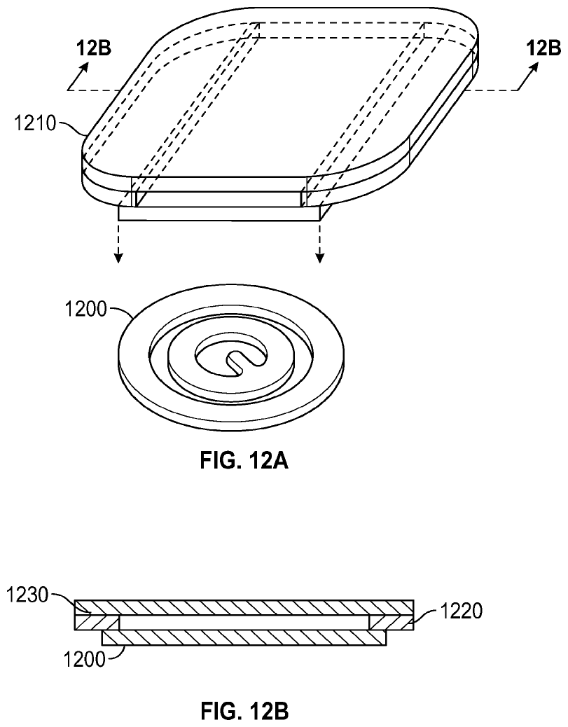

Another embodiment shown in FIG. 4 uses a focused CO₂ laser beam along with a material formed by a polypropylene or polyethylene layer and sealer 400 as the inner portion, an EVOH barrier 410 and an exterior PET layer 420. The energy from the laser beam is preferentially absorbed into the EVOH layer 410 when fired through either PE layer 400 from the inside of the package, or PET layer 420 from the outside of the package. When processed from the outside of the package, the print or colorant in the film on the exterior of the package may absorb and interfere with the etch operation by the laser. Depending on the material and application, the creation of a channel in the EVOH film also may compromise the barrier property of the film unless a second barrier layer is added as in the sealing film valve which extend over the channel features. The FIGS. 11 and 12A embodiments includes this second barrier layer. This layer can also serve as a sealing film valve.

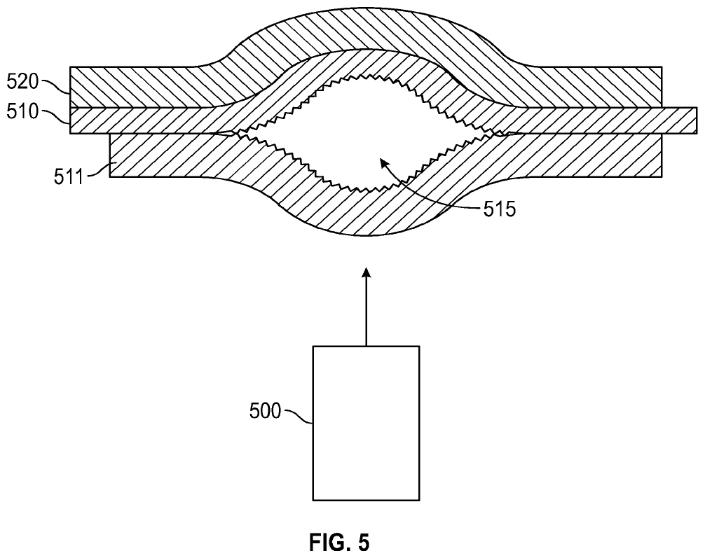

A shorter wavelength laser such as a fiber laser, operating around a 1.06 micron wavelength can be used as in FIG. 5. FIG. 5 illustrates how this shorter wavelength laser 500 can be used with a packaging film formed with an inner layer 511 of polypropylene or polyethylene and a sealer which can also include an interior PET or PA layer, an intermediate layer 510 formed of foil or metallized PET, and an exterior PET layer 520. The laser will preferentially absorb into the foil and metalized layers 510 without effecting the rest of the lamination. The absorption on the surface of the metal creates a heat affected zone 515 that will vaporize a small amount of the contacting plastic and create a bubble that is caused from the increased air pressure of the generated vapor which forms the channel 515. By pulsing the laser at different locations, a channel of interconnected bubbles can be created. A channel created by the laser in this manner is mostly created by deforming the structure of the film and not removing material as in other methods. The deformation can be partially reversed by physically crushing the film resulting in an inconsistent flow from feature to feature.

2. Interior Breach

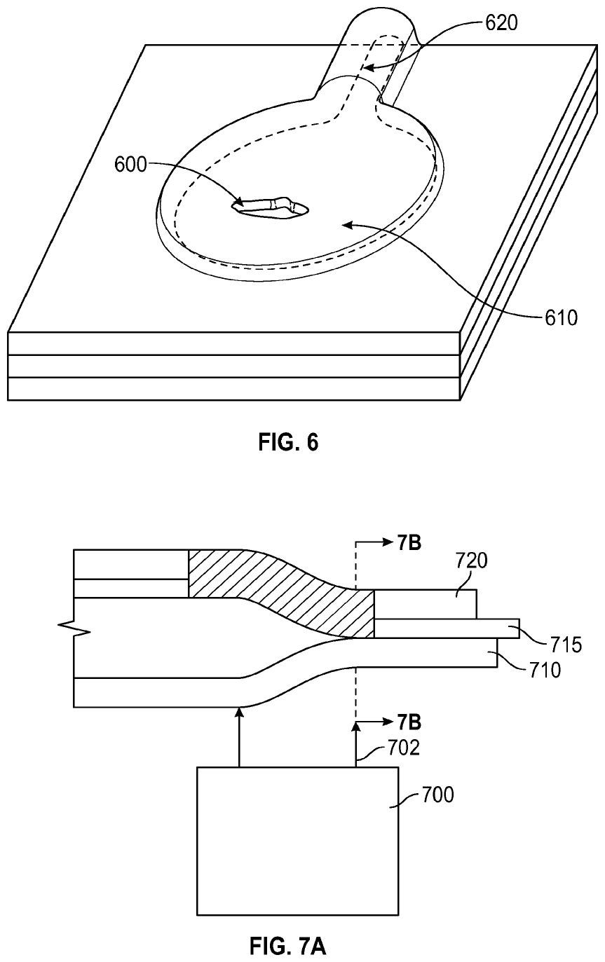

FIG. 6 illustrates how the interior breach 600 though the PE and PET layer to the channel can be accomplished with a focused CO₂ laser beam. The breach can be accomplished though application of more laser energy produced by the CO₂ laser resonator. A foil barrier layer as shown in embodiments described above can be used to act as a backstop to the additional power and prevent the laser from transmitting though the PE layer and breach the barrier and exterior PET layers. This creates a bubble area that has both a wide bubble part 610, and the channel part 620 which is therefore connected to the breach 600.

The interior breach size has little effect on the overall flow rate of the three-part system formed by the interior breach, channel, and exterior breach. The breach should be small or can in certain embodiments include features, such as a filter or strainer, to prevent coffee grounds or particles from blocking the channel. Such a feature may be created by the laser in a similar manner as the channels. The feature is an area of delamination of the interior and barrier layers that CO₂ gas would have to pass through to enter the channel on the way out of the package. The delamination area or channel grid area would increase overall air flow restriction very little and would create a place for coffee particles to settle or be filtered out before entering the channel and possibly blocking air flow through them.

3. Exterior Breach

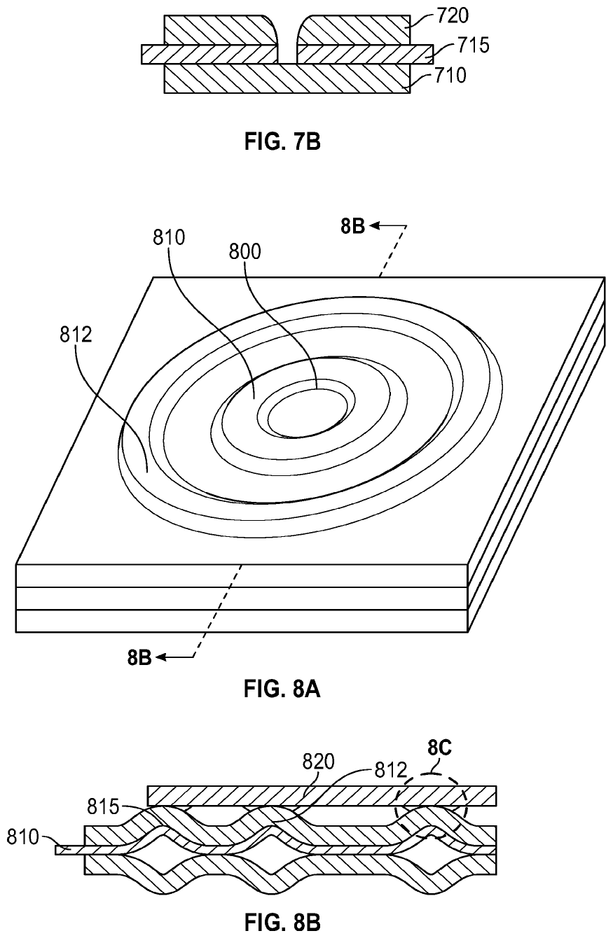

FIGS. 7A and 7B illustrate another example embodiment. A short wavelength laser such as a fiber laser 700 operating around 1.06 micron wavelength creates laser fire 702 directed at the layers, transmitting through a PP/PE layer 710, compromising the foil layer 715, and an exterior PET layer 720. This kind of laser is well suited to breaching foil layers. The laser wavelength is preferably absorbed by the foil while being transparent to most plastics, including the plastic layers 710 and 720. The breach can be completed by using the excess heat and particles thrown from the vaporized metal of the foil 715 to penetrate the exterior PET layer(s) 720. Excess heat can also reflect back though the interior layers 710, a layer of PET against the barrier layer operates to contain the reflected heat and vaporized particles better than a single layer of PE, thereby preventing an unwanted breach of the interior layer at the site of the exterior breach. The layer 710 can be a thicker PE/PET layer relative to the exterior layer 720, and this thicker layer on the interior also operates to reduce the chance of this unwanted breach. The breach from the channel to the exterior can also be completed by applying a focused CO₂ laser beam onto the exterior of the film intersecting the foil breach created by a fiber laser. Mechanical methods such as a die or needle can alternatively be used to create a breach from the interior and exterior of the film to the channel.

FIG. 7B shows a cross section across the line 7B-7B in FIG. 7A showing the interior layer 710, the foil layer 715 and exterior layer 720. In this embodiment, the interior and exterior layers can also be substituted by multiple stacked layers, e.g., a PE/PP layer and a barrier layer or multiple other layers of plastic materials.

4. Exterior Seal: Sealing Film Valve

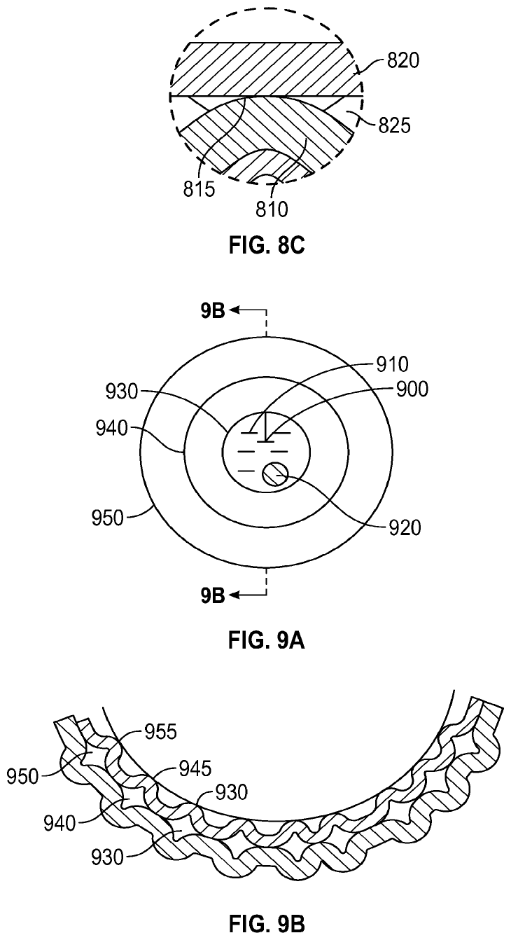

Previous embodiments show how channels created by the CO₂ or fiber lasers create a raised surface or ridge on both the interior and exterior of the film. The ridge can be crushed but returns to near original shape when pressure is released. This is because, in most cases, the film has a good memory for the ridge, caused by, at least in part, metal particles from the vaporized foil embedding into the interior and exterior layers, and binding those layers into their expanded shapes. The film also has a memory for the ridges by being heated during the formation of the bubble and cooling in the inflated state. The film cooling in the inflated shape defines its new natural or relaxed shape. The exception is when a certain kind of shortwave laser is used to create the channel. The shortwave laser may harden the aluminum and it therefore does not rebound from being crushed. In this embodiment shown in FIGS. 8A-8C, the ridges on the exterior of the film are used to create a sealing feature, which can be used in addition to the breach and channel that will restrict or prevent the counter flow of air into the package. This sealing feature may be located between the inner breach and outer breach. In FIG. 8A, the exterior (outer) breach 800 is surrounded by Channels 810, 812 that form circles or rings that circumscribe the exterior breach to assist in creating a seal. The seal is formed between the crest of the circular ridges and an additional layer of film 820.

FIG. 8B shows a cross-section of the FIG. 8A embodiment along the line 8B-8B. In this embodiment, the material is processed as described above to form the bubbles, to form bumps in the shape of rings of material such as 810, 812. The topmost portion of each of these bumps, e.g. 815 presses against the sealing film 820 that overlies the materials of the bumps.

This is shown in further detail in FIG. 8C where each bump has its top portion 815 pressing against the sealing film 820. The seal is increased and propagated by the addition of a light layer of oil or other wetting liquid or material that is attracted to the layer, shown as 825. The oil 825 creates an airtight seal between the film of the sealing film valve and the ridges of the package film.

In operation, gas pressure, e.g., CO₂, inside the package can cause pressure that will vent through the seal between the bumps 815 and the film layer 820. After the pressure is released, the seal is re-formed. The oil 825 also helps to re-form the seal after it has been broken, for example, by escaping CO₂ gas. The surface energy of the oil 825 forms a wetting meniscus between the sealing film 820 and the ridge 815 wherever the two are in contact. The meniscus draws the film to the ridge like a zipper closing. The seal can also be formed with a low durometer rubber, gel or a viscoelastic gel like the solidified mineral oil common in gel candles.

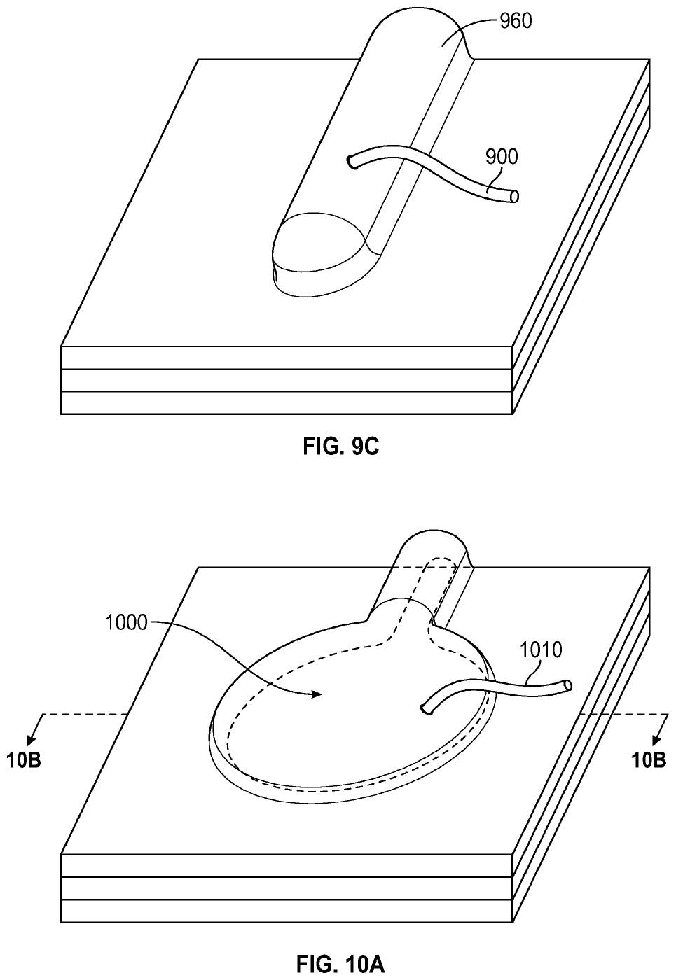

The film of the sealing film valve should lay completely flat on the circle to be most effective. If there is a gap between the ridge of the circle and the film, then outside air could get into the exterior breach. One way in which such a gap could be formed is by a wrinkle in the film. An alternative embodiment is shown in FIGS. 9A-9C. The concentric circles, or enclosed shapes, of ridges rise above the exterior surface of the film to a near uniform height as shown in FIGS. 9A-9C. FIG. 9A shows a top view of the exterior of the package, showing the exterior breach 900, as well as interior additional ridge features 910. The location 920 of the interior breach is also shown. In addition, there are several concentric sealing circles 930, 940, 950 that can seal between outside air and the exterior breach. These sealing circles seal along a tangent plane to the surface of the film, as explained herein, in a way that avoids problems caused by folds or wrinkles in the film.

A cross-section along the line 9B-9B is shown in FIG. 9A. This shows a slice of three concentric circles, 930, 940, 950. Each circle part has ridges, with the circle part 930 pressed against by ridges 935, the circle part 940 having ridges such as 945, and the circle part 950 having ridges such as 955. Each of these generally form a plane tangent to the surface of the film. The use of the tangent plane for sealing may reduce the chances of wrinkles or folds in the sealing film generated by a single protruding feature. Any such wrinkles or folds prevent a complete perimeter wetted seal between the ridge features and the sealing film valve. An incomplete perimeter wetted seal would allow air to enter the interior of the sealing feature and to the exterior breach.

FIG. 9C shows a close-up detail of the exterior breach 900, opening onto a section of the surface and on a channel ridge 960. Locations of the ridges may be as shown in the cross section of FIG. 9B, thereby sealing between the outside air and exterior breaches.

The interior package pressure required to break the meniscus seal decreases as the area of the circle the seal is formed on increases. The total force is a factor of pressure applied over an area. The seal on the smallest diameter circle determines the cracking pressure of the valve. In one embodiment, the escaping CO₂ is allowed to exit the exterior breach at a point that is lower than the raised surface of the ridges and sealing film. A wet seal encompassing the entire exterior breach would increase the cracking pressure by the inverse of the area of the exterior breach. The exterior breach 900 is located, in part, on a ridge created by a channel, according to one embodiment. An exterior breach that is created by a line that extends from a channel ridge to a non-etched surface as in FIG. 9C will allow escaping CO₂ gas to fill the inside of the circular seal and prevent uncontrolled backpressure.

Likewise, a pattern of ridges 910 on the inside of the concentric sealing features allows escaping CO₂ to distribute and pressurize the entire area inside of the sealing feature and helps to maintain a parallel surface for the sealing film to contact.

The cracking pressure of the valve can be set or designed to a level that would reduce the effect of changes in the barometric pressure which often fluctuates as much as 0.3 PSI per week. If the cracking pressure is set to zero, the package would experience a negative pressure or partial vacuum each time the barometric pressure increases. This negative pressure would increase the likelihood that exterior air and moisture would infiltrate the package. A cracking pressure of 0.3 PSI may be optimal to nearly eliminate the possibility of a negative pressure in the package due to barometric pressure changes.

The film that forms the seal is formed of a material that does not swell when exposed to the oil that is used on the interface of the seal. The layer of oil should be applied thick enough to form a complete meniscus on at least one of the concentric circles. Any oil in excess of forming a meniscus does not contribute much to the lowering of the OTR value. Excess oil may also increase the chances of oil flowing into the exterior breach. The exterior breach and the channel will increase in air flow resistance with the introduction of oil on their interior surfaces and too much oil may completely block the flow of CO₂ escaping.

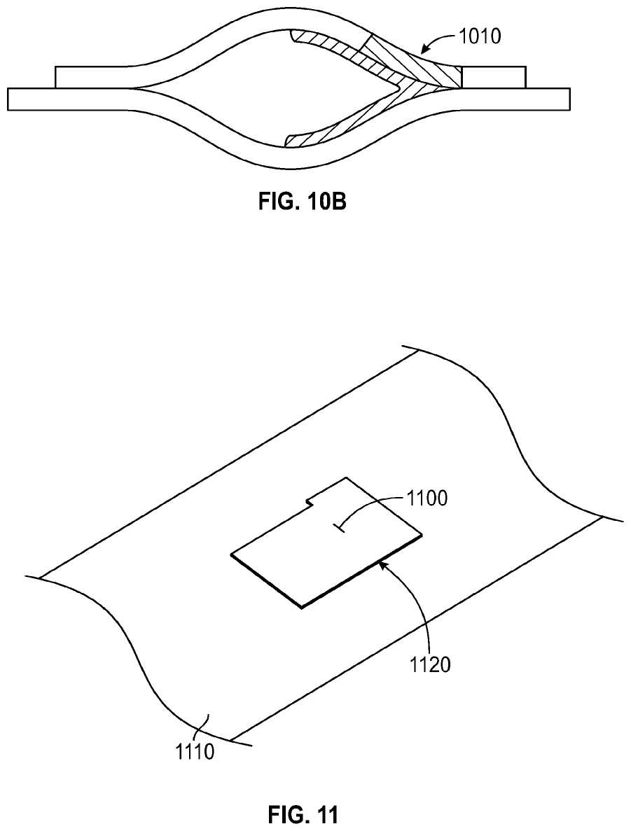

FIGS. 10A-10B illustrate an embodiment that has a feature to prevent oil from blocking or inhibiting the intended flow of air. The feature may include a delaminated area 1000 that inflates if infiltrated with oil. The inflation caused by the oil infiltration opens the air path to the exterior breach 1010. The area also creates a reservoir for any oil that enters the exterior breach 1010 and prevents the oil from entering the channels and possibly mixing with the coffee. FIG. 10B illustrates a cross section along the line 10B-10B in FIG. 10A.

This can be as further shown in FIGS. 12A and 12B; where FIG. 12A shows the laser etched vent feature 1200, which is etched into the packaging film over which a sealing film valve assembly is attached by pressure sensitive adhesive. FIG. 12B shows a cross sectional view along the line 12B-12B in FIG. 12A, showing how the valve 1200 is attached by adhesive 1220 on to a stiffening cover 1230 over the packaging film. According to another embodiment, the sealing film valve may also incorporate a pigment that is sensitive to different concentrations of CO₂ gas. The pigment is visible from the outside of the package and can be used as an indicator as to whether the CO₂ gas was being emitted from the vent. This can allow a user to tell at a glance how fresh the coffee is. When CO₂ is being emitted from the package, the coffee is typically very fresh, thus enabling the pigment to indicate coffee freshness. Stiffening layer 1230 holds the package film and the sealing film flat to one another.

5. Patch

Another example embodiment recognizes that gas generation in modified atmosphere packaging, or “MAP” sometimes builds up air pressure and the result is a package that balloons up. Some packages, however, may preferably be formed of a material 1301 that is not suitable for laser etching of a channel vent as in the previous embodiments. E.g., some clear PETs or PEs may not be laser etchable.

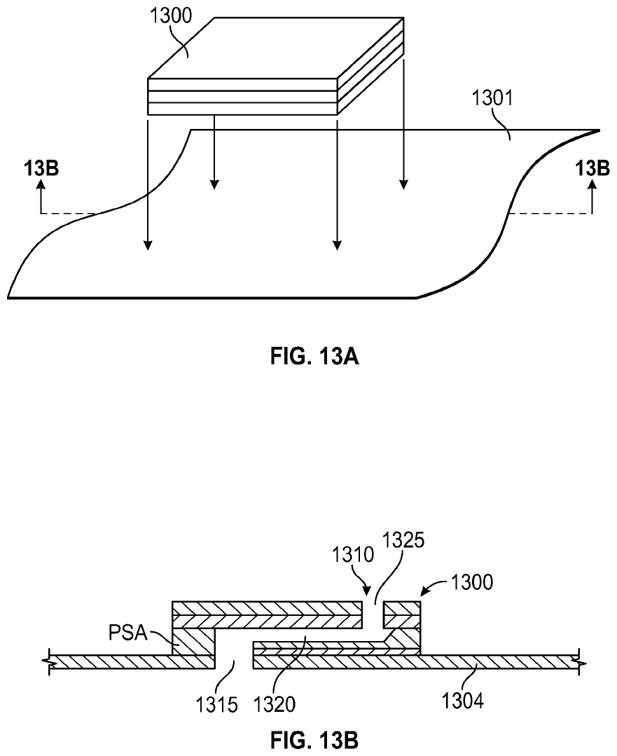

According to this embodiment, shown in FIGS. 13A-13B, a special “patch” added to a PSA label in order to carry out pressure relief while maintaining the cosmetic appearance. In this embodiment, a small multilayer patch 1300 is attached to either the package, or, as shown in the embodiment, as a lidding film such as a PSA label. The patch 1300 has a structure similar to coffee bag film as in FIG. 1 (Prior Art). A vent is etched into the patch though the package or lidding film as shown in FIG. 13B. The vent 1310 has an inner breach 1315, channel 1320 and outer breach 1325. The vent 1310 relieves the pressure in the package and has a low enough OTR not to effect the MAP gases in the package.

The operation can be very simple, e.g., a postage stamp sized (¾ inch by ¼ inch) coffee film PSA label 1300 is attached to the bag or lidding film 1301 by a label applicator. The patches move on the conveyor system under the lasers (CO₂ and short wave) and can be etched the same as the coffee film as in previous embodiments. The bag or lidding film may be cut with the CO₂ laser but this does not affect the channel formation. The bag or lidding film being cut will not affect the package's integrity as the PSA patch will hold it together. For MAP packaged produce, the sealing film valve would not be needed because of the shorter shelf life. A similar “Patch” application with the sealing film valve could be used for longer lived MAP products like dried fruits and nuts, if desired. This will allow a MAP package to be made out of clear PET (or other specialty material that cannot be processed by lasers as done herein) to show its contents and not rupture or balloon up.

Other embodiments are contemplated. For example, while the above embodiments have described a specific material, other materials could be included. Certain plastics which are laser transmissive, for example, can be used in place of the PE or PET described herein. Also, while these techniques can be used to protect coffee in a package, they can also be used to protect other materials in such a package.

Those of skill would further appreciate that these features can be carried out using different materials and different techniques different words and different shapes.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein, such as presented in the claims.

1. A vent for a package, comprising:
a multilayer laminate film comprising a vent having a first breach, a second breach, and a laser-formed channel extending therebetween, the length and cross-sectional area of the laser-formed channel configured to exhaust CO₂ at a rate greater than a counter-flow diffusion rate for oxygen or water vapor.

2. The vent of claim 1, further comprising wherein the vent has an OTR of between about 1.5 ml to about 0.01 ml per day.

3. The vent of claim 2, further comprising wherein a diameter of the laser-formed channel is between about 50 microns to about 200 microns.

4. The vent of claim 3, further comprising wherein the vent can exhaust up to about 500 ml of CO₂ at 1 PSI in around 24 hours.

5. The vent of claim 3, further comprising wherein a first layer of the multilayer laminate film is laser transmissive.

6. The vent of claim 5, further comprising wherein a second layer of the multilayer laminate film is laser absorptive.

7. The vent of claim 6, further comprising wherein a third layer of the multilayer laminate film is laser reflective.

8. The vent of claim 6, further comprising wherein the laser-formed channel is formed in the second layer.

9. The vent of claim 8, further comprising wherein the laser-formed channel is inflated and expanded beyond an original thickness of the second layer.

10. The vent of claim 8, further comprising wherein either of the first breach or the second breach comprises a laser formed breach.

11. The vent of claim 8, further comprising wherein either of the first breach or the second breach comprises a mechanically cut breach.

12. The vent of claim 1, further comprising wherein the multilayer laminate film is a package film, and the first breach is in communication with an interior of a package comprising the package film and the second breach is in communication with an exterior of the package.

13. The vent of claim 1, further comprising wherein the multilayer laminate film is a patch comprising an adhesive layer for adhesion to a package film exterior surface, and the first breach is configured for communication with an interior of a package comprising the package film and the second breach is configured for communication with an exterior of the package.

14. The vent of claim 13, further comprising a wetted sealing film over the second breach.

15. The vent of claim 14, further comprising wherein the vent has an OTR of less than 0.01 ml per day.

16. The vent of claim 13, further comprising wherein the multilayer laminate film patches are provided on a roll stock.

17. The vent of claim 16, further comprising wherein the vent is configured to be crushed when the roll stock is rolled-up and to subsequently inflate in size when the roll stock is unrolled.

18. A vent for a package, comprising:
a multilayer laminate film comprising a vent having a first breach configured for communication with an interior of a package comprising the multilayer laminate film, a second breach configured for communication with an exterior of the package, and a laser-formed channel communicating therebetween, wherein a diameter of the laser-formed channel is between about 50 microns to about 200 microns.

19. The vent of claim 18, further comprising wherein the vent has an OTR of between about 1.5 ml to about 0.01 ml per day.

20. The vent of claim 19, further comprising wherein the vent can exhaust up to about 500 ml of CO₂ at 1 PSI in around 24 hours.
